(19) United States
(12) Patent Application Publication
(10) Pub. No.: US 2016/0063567 A1
(43) Pub. Date: Mar. 3, 2016

(54) MARKETING PLATFORM THAT IDENTIFIES PARTICULAR USER ATTRIBUTES FOR MARKETING PURPOSES

(71) Applicant: Verizon Patent and Licensing Inc., Arlington, VA (US)

(72) Inventor: Ashok N. SRIVASTAVA, Mountain View, CA (US)

(21) Appl. No.: 14/473,095

(22) Filed: Aug. 29, 2014

(51) Int. Cl. G06Q 30/02

(52) U.S. Cl. CPC G06Q 30/0269

(57) ABSTRACT

A device receives user information associated with users of user devices, and receives marketing information associated with advertisements for products or services. The device generates user profiles, associated with the users, based on the user information, and determines one or more particular attributes associated with at least one of the advertisements. The device identifies a particular user profile, of the user profiles, that includes the one or more particular attributes. The particular user profile is associated with a particular user, and the particular user is associated with a particular user device. The device determines a particular advertisement to provide to the particular user device based on the particular user profile and the marketing information, and causes the particular advertisement to be provided to the particular user device.

### BACKGROUND

Users today utilize a variety of user devices, such as cell phones, smart phones, tablet computers, etc., to access online services (e.g., email applications, Internet services, television services, etc.), purchase products and/or services, and/or perform other tasks.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIGS. 4A and 4B depict a flow chart of an example process for identifying particular users with particular attributes and providing advertisements to the particular users; and

FIGS. 5A-5F are diagrams of an example relating to the example process shown in FIGS. 4A and 4B.

### DETAILED DESCRIPTION OF PREFERRED EMBODIMENTS

The following detailed description refers to the accompanying drawings. The same reference numbers in different drawings may identify the same or similar elements.

Information associated with user devices (e.g., locations of the user devices when tasks are performed, times associated with when the user devices perform the tasks, network resources utilized by the user devices, etc.) and information associated with content accessed by the user devices (e.g., clickstream information associated with the user devices) may be collected by a provider of a network. Information associated with the users (e.g., preferences and other information) may be shared with vendors (e.g., businesses, organizations, etc.) that provide such products and/or services so that the users can access and interact with the vendors in an efficient manner.

Vendors are constantly trying to find out as much about users as possible so that the vendors can market appropriate products and/or services to the users via advertisements (ads). However, most vendors know very little about the users of their products and/or services. The vendors may utilize multiple marketing channels (e.g., online advertisements, email advertisements, etc.) to provide the advertisements to the users. Thus, the vendors are also constantly trying to figure out how to allocate a marketing budget so that appropriate advertisements are provided to appropriate users at appropriate times and via appropriate marketing channels.

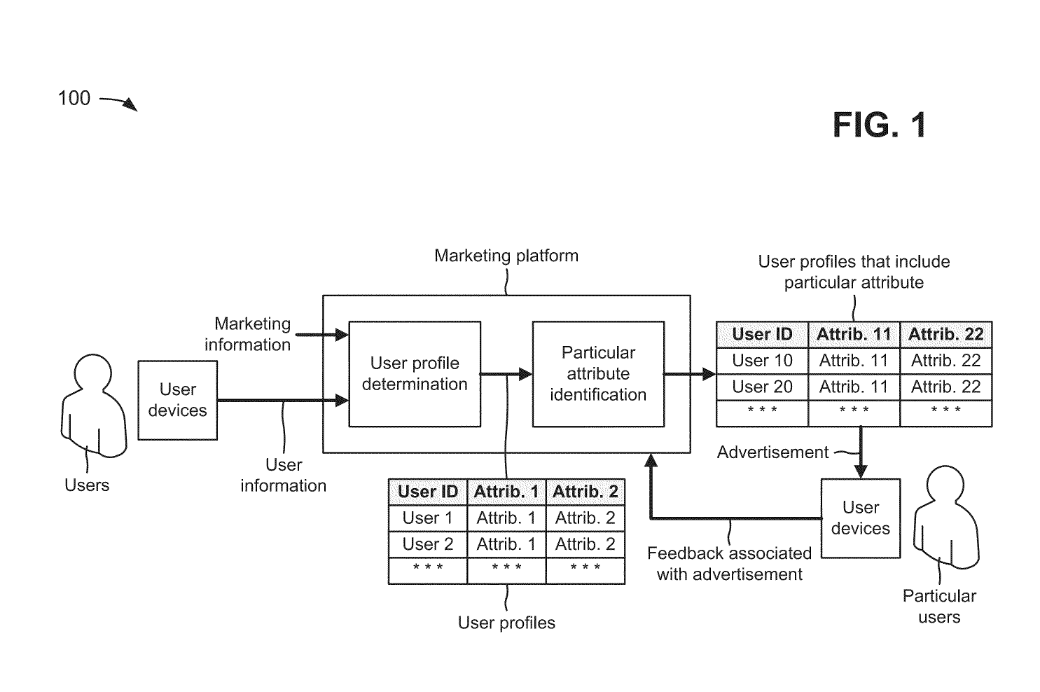

FIG. 1 is a diagram of an overview of an example implementation 100 described herein. In example implementation 100, assume that a marketing platform is associated with multiple user devices and corresponding users. The marketing platform may receive user information from the user devices, and may receive marketing information from other sources. The user information may be generated by the multiple user devices, and may include information associated with the user devices and the users, network information, etc. The user information may be stored in the user devices and/or in a network resource (e.g., a server device), and provided to the marketing platform. The marketing information may include information associated with products and/or services offered by vendors and to be marketed to the users, advertisements for the products and/or the services, etc.

The marketing platform may include a user profile determination component and a particular attribute identification component. The user profile determination component may create user profiles for the users based on the user information and the marketing information. For example, the user profile determination component may create a user profile, for a particular user, that includes a user identifier (ID) (e.g., a unique user name, a user identification number, etc.) and multiple attributes associated with the particular user (e.g., demographic information, location information, time information, user device information, etc.). The user profile determination component may provide the user profiles to the particular attribute identification component.

The particular attribute identification component may define one or more particular attributes for marketing a particular product and/or service. For example, the particular attribute identification component may determine that the particular product/service is a dinner special at a restaurant located in downtown Philadelphia, and may define a location attribute (e.g., the user devices located in downtown Philadelphia) and a time attribute (e.g., dinner time or around 6:00 PM) for the particular product/service. The particular attribute identification component may identify particular user profiles (e.g., for particular users) that include the particular attributes. For example, the particular attribute identification component may identify user profiles that are associated with users located in downtown Philadelphia at dinner time (e.g., daily, a predetermined number of times, etc.).

The particular attribute identification component may determine an advertisement (e.g., for the particular product/service) to provide to the particular users based on the particular user profiles and/or the marketing information. As further shown in FIG. 1, the particular attribute identification component may cause the advertisement to be provided to the user devices associated with the particular users. The particular attribute identification component may provide the advertisements to the user devices in a variety of formats, such as via an online advertisement (e.g., an Internet advertisement), via a mobile advertisement (e.g., an advertisement sent to an application(s) executed by mobile devices), via a short message service (SMS) advertisement, via a payment application (e.g., a credit card application, a debit card application, etc.), via a point of sale (POS) or checkout device (e.g., device at which a user makes a payment in exchange for products and/or services), via a television advertisement, via an email advertisement, etc.

The particular users may receive the advertisement (e.g., via the user devices), and may generate feedback (e.g., indicating whether the particular users were provided the advertisement, purchased the product/service associated with the advertisement, visited web pages relating to the advertisement, requested that the advertisement not be provided in the future, etc.) associated with the advertisement. The user devices may provide the feedback to the marketing platform. The marketing platform may utilize the feedback to refine, improve, and/or modify the user profile determination component, the particular attribute identification component, and/or the user profiles.

Systems and/or methods described herein may provide a marketing platform that identifies particular attributes for particular user profiles generated by the marketing platform, and that provides advertisements to particular users associated with the particular user profiles. The systems and/or methods may ensure that personalized advertisements are delivered to the particular users at appropriate times and locations. The systems and/or methods may enable vendors to allocate marketing budgets so that the personalized advertisements are provided to the particular users in a most productive manner.

As used herein, the term user is intended to be broadly interpreted to include a user device, or a user of a user device. The term vendor, as used herein, is intended to be broadly interpreted to include a business, an organization, a government agency, a vendor device, a user of a vendor device, etc.

A product, as the term is used herein, is to be broadly interpreted to include anything that may be marketed or sold as a commodity or a good. For example, a product may include bread, coffee, bottled water, milk, soft drinks, pet food, beer, fuel, meat, fruit, automobiles, clothing, content, etc. The term content, as used herein, is to be broadly interpreted to include video, audio, images, text, software downloads, and/or combinations of video, audio, images, text, and software downloads.

A service, as the term is used herein, is to be broadly interpreted to include any act or variety of work done for others (e.g., for compensation). For example, a service may include a repair service (e.g., for a product), a warranty (e.g., for a product), a telecommunication service (e.g., a telephone service, an Internet service, a network service, a radio service, a television service, a video service, etc.), an automobile service (e.g., for selling automobiles), a food service (e.g., a restaurant), a banking service, a lodging service (e.g., a hotel), etc.

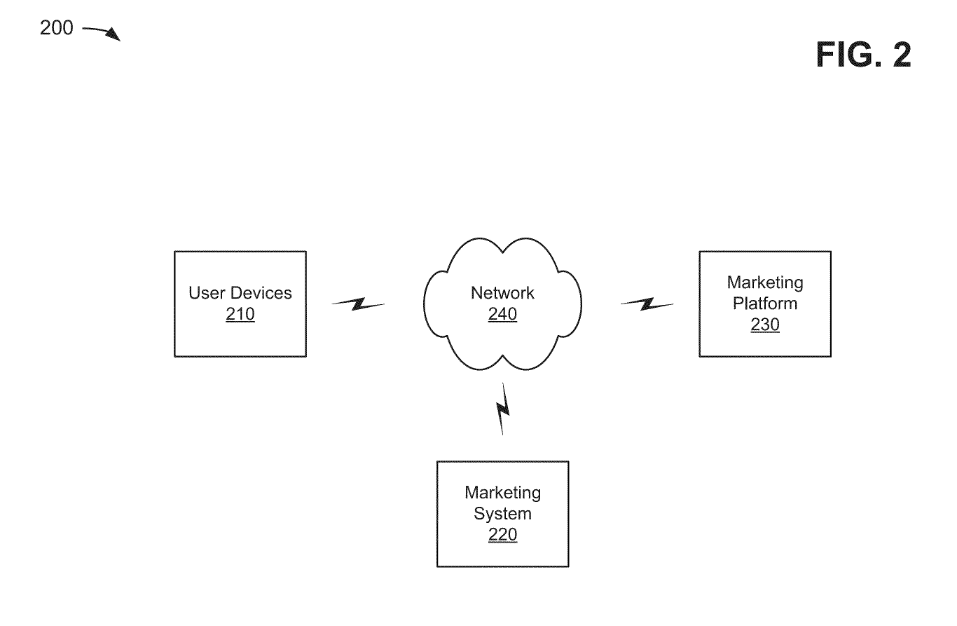

FIG. 2 is a diagram of an example environment 200 in which systems and/or methods described herein may be implemented. As illustrated, environment 200 may include user devices 210, a marketing system 220, a marketing platform 230, and a network 240. Devices/networks of environment 200 may interconnect via wired connections, wireless connections, or a combination of wired and wireless connections.

User device 210 may include a device that is capable of communicating over network 240 with marketing system 220 and/or marketing platform 230. In some implementations, user device 210 may include a radiotelephone; a personal communications services (PCS) terminal that may combine, for example, a cellular radiotelephone with data processing and data communications capabilities; a smart phone; a configured television; a personal digital assistant (PDA) that can include a radiotelephone, a pager, Internet/intranet access, etc.; a laptop computer; a tablet computer; a global positioning system (GPS) device; a gaming device; a set-top box (STB); or another type of computation and communication device. In some implementations, user device 210 may be associated with a service provider that manages and/or operates network 240, such as, for example, a telecommunication service provider, a television service provider, an Internet service provider, a wireless service provider, etc.

Marketing system 220 may include one or more personal computers, one or more workstation computers, one or more server devices, one or more virtual machines (VMs) provided in a cloud computing network, and/or one or more other types of computation and communication devices. In some implementations, marketing system 220 may be associated with one or more vendors or other entities that provide marketing services for the vendors. In some implementations, marketing system 220 may enable vendors to generate marketing information, and to provide the marketing information to user devices 210 and/or marketing platform 230. The marketing information may include information associated with products and/or services offered by the vendors and to be marketed to the users; advertisements for the products and/or the services offered by the vendors; marketing campaign information (e.g., a campaign for a particular product and/or service, a marketing budget for the campaign, timing associated with the campaign, etc.); interactions (e.g., transactions, creation of user accounts with the vendors, creation of user profiles with the vendors, etc.) between the vendors and the users (e.g., between marketing system 220 and user devices 210); etc.

Marketing platform 230 may include one or more personal computers, one or more workstation computers, one or more server devices, one or more VMs provided in a cloud computing network, and/or one or more other types of computation and communication devices. In some implementations, marketing platform 230 may be associated with a service provider that manages and/or operates network 240, such as, for example, a telecommunication service provider, a television service provider, an Internet service provider, a wireless service provider, etc.

In some implementations, marketing platform 230 may receive user information associated with users of network 240, and may receive marketing information associated with products and/or services offered by vendors and/or marketed by marketing system 220. Marketing platform 230 may create user profiles based on the user information and/or the marketing information, and may define a particular attribute(s) for marketing a particular product/service. Marketing platform 230 may identify particular user profiles that include the particular attribute(s), and may determine an advertisement, for the particular product/service, to provide to particular users based on the particular user profiles and the marketing information. Marketing platform 230 may cause the advertisement to be provided to particular user devices 210 associated with the particular users, and may receive feedback associated with the advertisement from the particular user devices 210. Marketing platform 230 may utilize the feedback to refine the identification of the particular user profiles.

Network 240 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks. In some implementations, network 240 may be associated with a service provider (e.g., and be referred to as a service provider network) that manages and/or operates network 240, such as, for example, a telecommunication service provider, a television service provider, an Internet service provider, a wireless service provider, etc.

In some implementations, the cellular network may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN), and may include one or more base stations. The EPC network may include an all-Internet protocol (IP) packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN) RAN. The IMS network may include an architectural framework or network (e.g., a telecommunications network) for delivering IP multimedia services. The PDN may include a communications network that is based on packet switching. In some implementations, the cellular network may provide location information (e.g., latitude and longitude coordinates) associated with user devices 210. For example, the cellular network may determine a location of user device 210 based on triangulation of signals, generated by user device 210 and received by multiple base stations, with prior knowledge of the base stations.

In some implementations, the satellite network may include a space-based satellite navigation system (e.g., a global positioning system (GPS)) that provides location and/or time information in all weather conditions, anywhere on or near the Earth where there is an unobstructed line of sight to four or more satellites (e.g., GPS satellites). In some implementations, the satellite network may provide location information (e.g., GPS coordinates) associated with user devices 210, enable communication with user devices 210, etc.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

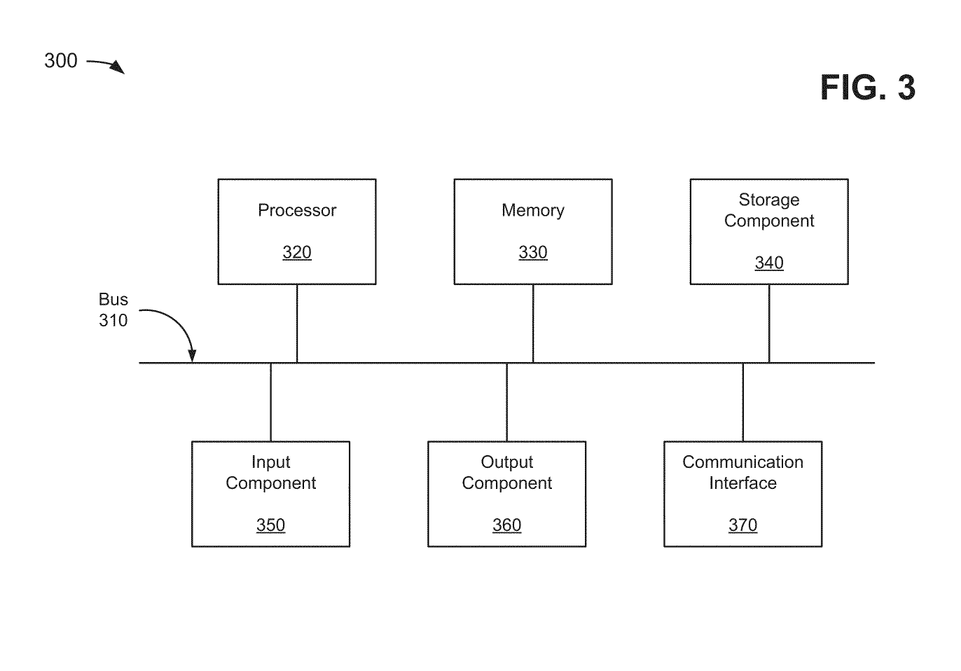

FIG. 3 is a diagram of example components of a device 300 that may correspond to one or more of the devices of environment 200. In some implementations, each of the devices of environment 200 may include one or more devices 300 or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

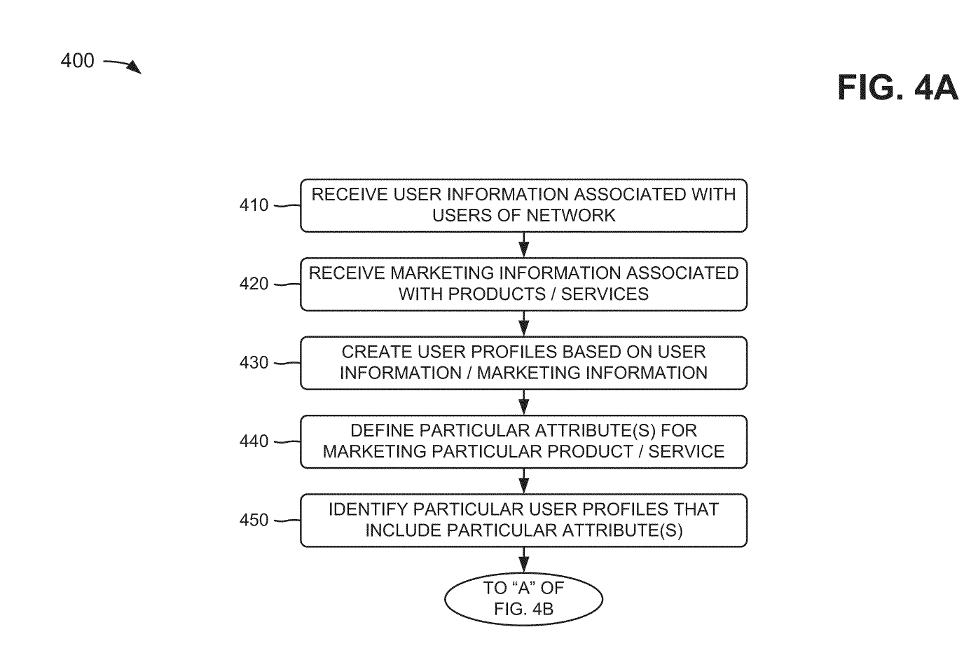

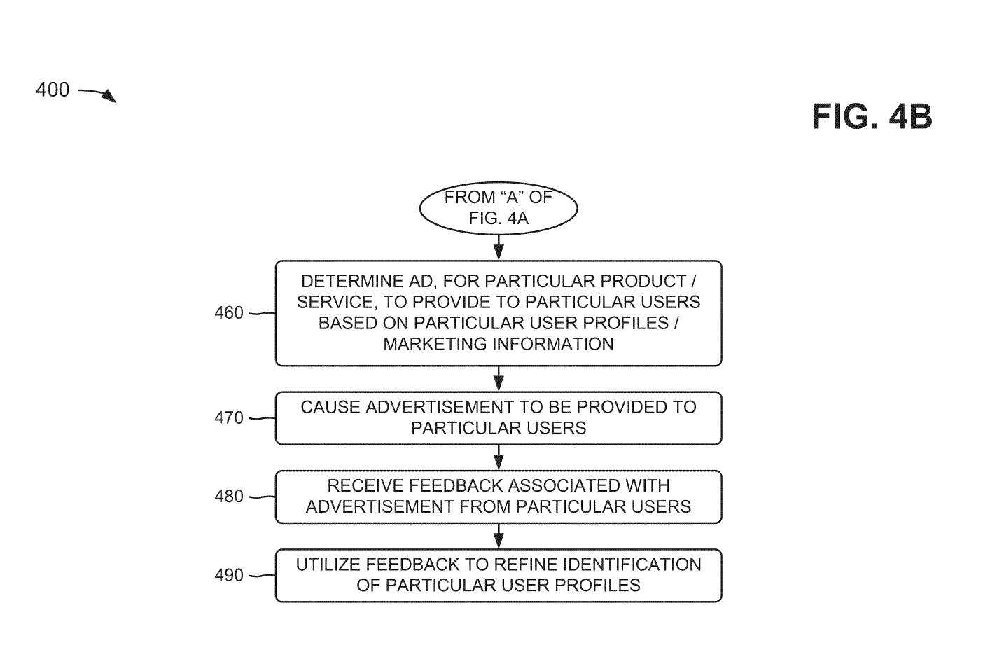

FIGS. 4A and 4B depict a flow chart of an example process 400 for identifying particular users with particular attributes and providing advertisements to the particular users. In some implementations, one or more process blocks of FIGS. 4A and 4B may be performed by marketing platform 230. In some implementations, one or more process blocks of FIGS. 4A and 4B may be performed by another device or a group of devices separate from or including marketing platform 230, such as user device 210 and/or marketing system 220.

As shown in FIG. 4A, process 400 may include receiving user information associated with users of a network (block 410). For example, marketing platform 230 may receive, from user devices 210, user information associated with users of network 240. In some implementations, the user information may include information associated with user devices 210 (e.g., types of user devices 210, model numbers of user devices 210, etc.); information associated with the users of user devices 210 (e.g., account information, demographic information, etc.); network information (e.g., information associated with network resources of network 240 utilized by user devices 210); usage information associated with network 240 by user devices 210; content accessed by user devices 210; transactions associated with user devices 210; clickstream information associated with user devices 210; location information associated with user devices 210; time information associated with user devices 210; etc.

The clickstream information may include information associated with portions of user interfaces that users select (e.g., or click on) while web browsing (e.g., accessing content) or while using a software application. The location information may include information associated with locations (e.g., global positioning system (GPS) coordinates, cellular triangulation locations, etc.) of user devices 210 when content is accessed by user devices 210. In some implementations, the location information may include information associated with a current location of user device 210, proximity of user device 210 to something (e.g., another user device 210, a store, etc.), travel patterns of user device 210 (e.g., stops at a particular coffee shop on his way to work each day, drives home from work at 6:00 PM, a route traveled by user device 210, etc.), travel information (e.g., relating to an upcoming trip), a current location of another user device 210 (e.g., of a family member), etc. The time information may include information associated with times when user devices 210 access the content (e.g., dates and times when the content is accessed, an amount of time the user devices are performing online activities, such as browsing, etc.). In some implementations, the time information may include information associated with holidays, birthday(s), meetings, time of day, time of a week, etc.

In some implementations, user devices 210 may receive user information from users when the users register user devices 210 for a service (e.g., a telephone service, an Internet service, a television service, etc.), and such user information may include registration information, such as names, home addresses, contact information, account types, demographic information, gender information, etc. In some implementations, marketing platform 230 may continuously receive the user information from user devices 210 and/or network 240. In some implementations, marketing platform 230 may periodically (e.g., hourly, daily, weekly, etc.) receive the user information from user devices 210 and/or network 240. In some implementations, the user information may be stored in user devices 210 and/or in a network resource (e.g., a server device) of network 240, and continuously and/or periodically provided to marketing platform 230.

In some implementations, user device 210 may include an application that monitors, with the user's approval, actions taken in relation to user device 210. The application, on user device 210, may continuously transmit the monitored information (e.g., the user information and information identifying the user) to marketing platform 230, or may cause user device 210 to store the monitored information and provide the monitored information when requested by marketing platform 230 (e.g., during times when traffic of network 240 is low).

As further shown in FIG. 4A, process 400 may include receiving marketing information associated with products and/or services (block 420). For example, marketing platform 230 may receive marketing information from marketing system 220. The marketing information may include information associated with products and/or services offered by vendors and to be marketed to the users; advertisements for the products and/or the services offered by the vendors; marketing campaign information (e.g., a campaign for products and/or services, a marketing budget for the campaign, timing associated with the campaign, etc.); user information received by the vendors via interactions between the vendors and the users; etc.

As further shown in FIG. 4A, process 400 may include creating user profiles based on the user information and/or the marketing information (block 430). For example, marketing platform 230 may create user profiles, for the users, based on the user information and/or the marketing information. In some implementations, a user profile, for a particular user, may include a user identifier (ID) (e.g., a unique user name, a user identification number, etc.) and multiple attributes associated with the particular user (e.g., demographic information, location information, time information, user device information, interests, behavior, advertisements received, purchases made, etc.). For example, assume that a particular user (e.g., Susan) utilizes a mobile user device 210 (e.g., a smart phone), and that location information associated with the smart phone indicates that Susan is at a particular location (e.g., at a beach) every weekend. Further, assume that Susan utilizes the smart phone to receive advertisements associated with restaurants at the beach. In such an example, marketing platform 230 may create a user profile for Susan that includes information indicating interests of Susan (e.g., Susan is interested in the beach), behavior of Susan (e.g., Susan travels to the beach), advertisements received by Susan (e.g., Susan receives beach restaurant advertisements via the mobile user device 210), etc.

In another example, assume that a particular user (e.g., Fred) utilizes a particular user device 210 (e.g., a gaming device) to play online games, and that Fred utilizes the gaming device to shop for online games. Further, assume that Fred utilizes the gaming device to receive advertisements associated with new online games when Fred shops for online games. In such an example, marketing platform 230 may create a user profile for Fred that includes information indicating interests of Fred (e.g., Fred is interested in online games), behavior of Fred (e.g., Fred shops online for games), advertisements received by Fred (e.g., Fred receives new online games advertisements via the gaming device), etc.

In still another example, assume that a particular user (e.g., Jane) plays golf, and utilizes a mobile user device 210 (e.g., a tablet) when playing golf and to purchase golf equipment (e.g., golf clubs, golf balls, etc.). Further, assume that Jane utilizes the tablet to receive advertisements associated with golf lessons when Jane purchases the golf equipment. In such an example, marketing platform 230 may create a user profile for Jane that includes information indicating interests of Jane (e.g., Jane is interested in golf), behavior of Jane (e.g., Jane purchases golf equipment via the mobile user device 210), advertisements received by Jane (e.g., Jane receives golf lesson advertisements via the mobile user device 210), etc.

In some implementations, marketing platform 230 may store the user profiles in a data structure (e.g., a tree, a table, a list, a database, a matrix, etc.) that includes a user ID field, multiple fields associated with attributes of the users (e.g., an account type field, a demographic field, an address field, a usage field, a network field, a transaction field, a contact information field, a gender field, a location field, a time field, etc.), and multiple entries associated with the fields. In some implementations, marketing platform 230 may store the user profiles in memory 330 and/or storage component 340 (FIG. 3) of marketing platform 230. In some implementations, marketing platform 230 may store the user profiles in a storage device separate from marketing platform 230.

In some implementations, the user profiles may be stored as a user profile matrix (Z) that includes a user ID column (i) and columns for multiple attributes, such as a location attribute (u), a time attribute (t), a demographic attribute (d), etc. The user profile matrix (Z) may include an n×p matrix, where n may indicate a number of users and p may indicate a number of attributes. In one example, the user profile matrix (Z) may include the following form:

$$Z = [ \begin{matrix}{i}_{1} & {u}_{1} & {t}_{1} & {d}_{1} & … & {p}_{1} \\ {i}_{2} & {u}_{2} & {t}_{2} & {d}_{2} & … & {p}_{2} \\ … & … & … & … & … & … \\ {i}_{u} & {u}_{n} & {t}_{n} & {d}_{n} & … & {p}_{n}\end{matrix} ] .$$

As further shown in FIG. 4A, process 400 may include defining one or more particular attributes for marketing a particular product and/or service (block 440). For example, marketing platform 230 may receive, from marketing system 220, a request to market a particular product and/or service to the users of user devices 210. In some implementations, marketing platform 230 may identify (e.g., based on the marketing information) the particular product and/or service to market to the users of user devices 210. For example, marketing platform 230 may receive or identify information associated with a restaurant (e.g., a diner) that sells food at a particular location (e.g., 499 Hamilton Avenue, Palo Alto, Calif.) at a particular time (e.g., lunch time (e.g., 11:00 AM to 2:00 PM) during weekdays).

In some implementations, marketing platform 230 may define one or more particular attributes (e.g., provided in the user profiles), associated with the users, that are relevant to marketing the particular product and/or service. Returning to the example described above, marketing platform 230 may define a location attribute (e.g., current locations of user devices 210) and a time attribute (e.g., lunch time during the week) as being relevant to marketing the particular product and/or service. Marketing platform 230 may determine the location attribute and the time attribute to be relevant since the diner sells food at a particular location and at a particular time. In some implementations, marketing platform 230 may create an indicator vector (Y) that may include entries that equal “1” if the particular attributes are satisfied and may include entries that equal “0” if at least one of the particular attributes is not satisfied. For example, if a particular user is located at the particular location (e.g., 499 Hamilton Avenue, Palo Alto, Calif.) at the particular time (e.g., between 11:00 AM to 2:00 PM during weekdays), the entry for the particular user in the indicator vector (Y) may be set to “1.” However, if the particular user is located at another location (e.g., San Francisco, Calif.) at the particular time, the entry for the particular user in the indicator vector (Y) may be set to “0.” In some implementations, the indicator vector (Y) may include a n×1 vector (e.g., where n may indicate a number of users) of the following form:

$$Y = [ \begin{matrix}0 \\ 1 \\ … \\ 1\end{matrix} ] .$$

As further shown in FIG. 4A, process 400 may include identifying user profiles that include the particular attribute(s) (block 450). For example, marketing platform 230 may identify particular user profiles that include the one or more particular attributes that are relevant to marketing the particular product and/or service. In some implementations, marketing platform 230 may perform calculations with the user profile matrix (Z) and the indicator vector (Y) in order to identify the particular user profiles that include the one or more particular attributes.

In some implementations, marketing platform 230 may utilize machine learning algorithms to identify the particular user profiles that include the one or more particular attributes. For example, marketing platform 230 may utilize supervised learning to identify the particular user profiles that include the one or more particular attributes. Supervised learning may include inferring a function from training data that includes a set of training examples. In supervised learning, each training example may include an input object (e.g., a vector) and a desired output value (or supervisory signal). A supervised learning algorithm may analyze the training data, and may produce an inferred function that can be used for mapping new examples.

In one example, assume that marketing platform 230 is trying to determine which users are most likely to be located at a particular location (e.g., 499 Hamilton Avenue, Palo Alto, Calif.) at a particular time (e.g., between 11:00 AM to 2:00 PM during weekdays). In such an example, marketing platform 230 may attempt to identify the particular user profiles (e.g., a subset of the user profile matrix (Z)) that correlate with the particular attributes (e.g., the location attribute (u) and the time attribute (t)). In some implementations, marketing platform 230 may identify the particular user profiles (θ) by solving the following regularized or logistic regression problem:

$${minimize}_{θ} {‖ Z ( u , t ) θ - Y ‖}_{2}^{2} + λ {‖ θ ‖}_{1} ,$$

where λ is a regularization parameter that provides control. The solution of the regularized regression problem may include the particular user profiles (θ) that are most likely to be located at the particular location at the particular time. In some implementations, prior to solving the regularized regression problem, marketing platform 230 may divide the location attribute (u) into smaller geographical regions if the location attribute defines a geographical region that is much larger (e.g., more than a particular threshold) than a geographical region encompassed by the particular location. In some implementations, prior to solving the regularized regression problem, marketing platform 230 may divide the time attribute (t) into smaller time segments (e.g., in seconds, minutes, hours, etc.) if the time attribute defines a time segment that is much larger (e.g., more than a particular threshold) than a time segment encompassed by the particular time.

In some implementations, marketing platform 230 may omit user profiles from the particular user profiles (θ) based on attributes (e.g., other than the particular attributes) associated with the omitted user profiles. For example, if a particular user profile indicates that a particular user is not in proximity to the particular location, does not like the type of food served at the restaurant, or does not like receiving advertisements (e.g., via user device 210), marketing platform 230 may omit the particular user profile. In some implementations, marketing platform 230 may assign weights (e.g., values, percentages, etc.) to different information (e.g., attributes) associated with the particular user profiles, such as interests (e.g., sports, weather, news, etc.) associated with the particular users, behavior (e.g., watch sports on television, shop online, etc.) associated with the particular users, types of advertisements (e.g., television, online, print, email, etc.) received by the particular users, etc.

In some implementations, marketing platform 230 may calculate a score for each of the particular user profiles based on the assigned weights. For example, assume that marketing platform 230 assigns a weight of 0.3 to interests associated with the particular users, a weight of 0.9 to behavior associated with the particular users, and a weight of 0.1 to the types of advertisements received by the particular users. Further, marketing platform 230 may identify three particular user profiles (e.g., X, Y, and Z) that include the particular attributes, and may calculate a score of 0.8 for particular user profile X, a score of 0.6 for particular user profile Y, and a score of 0.7 for particular user profile Z. In such an example, marketing platform 230 may omit particular user profile Y since particular user profile Y has the lowest score.

As shown in FIG. 4B, process 400 may include determining an advertisement, for the particular product and/or service, to provide to particular users based on the particular user profiles and the marketing information (block 460). For example, marketing platform 230 may identify an advertisement in the marketing information. In some implementations, marketing platform 230 may identify, in the marketing information, an advertisement for the particular products and/or service associated with a vendor. For example, assume that the marketing information includes information associated with a vendor (e.g., a sporting goods store), a product offered by the vendor (e.g., sporting goods), and an online advertisement created by or for the sporting goods store. In such an example, marketing platform 230 may identify the online advertisement in the marketing information.

In some implementations, marketing platform 230 may determine an advertisement (e.g., identified in the marketing information) to provide to the particular users (e.g., user devices 210) based on the determined particular user profiles. In some implementations, marketing platform 230 may calculate scores for multiple advertisements based on the marketing information. In some implementations, marketing platform 230 may assign weights (e.g., values, percentages, etc.) to different factors (e.g., of the marketing information) to be used to determine scores for the multiple advertisements, such as whether the advertisements are received by the particular users, whether the particular users buy products/services based on the advertisements, a number of the particular users that receive the advertisements, types of advertisements (e.g., online, print, email, etc.), etc. In some implementations, marketing platform 230 may calculate a score for each of the multiple advertisements based on the factors and the assigned weights. For example, assume that marketing platform 230 assigns a weight of 0.3 to whether the advertisements are received by the particular users, a weight of 0.9 to whether the particular users buy products/services based on the advertisements, a weight of 0.4 to the number of the particular users that receive the advertisements, and a weight of 0.1 to the types of advertisements. Further, marketing platform 230 may identify three advertisements (e.g., A, B, and C) in the marketing information, and may calculate a score of 0.8 for advertisement A, a score of 0.6 for advertisement B, and a score of 0.7 for advertisement C.

In some implementations, marketing platform 230 may determine particular advertisements to provide to the particular users based on the products/services associated with the particular advertisements and based on the particular user profiles associated with the particular users. For example, assume that marketing platform 230 identifies the particular users since the particular users are always located in downtown Palo Alto during lunch time (e.g., since the particular users work in downtown Palo Alto). Further, assume that marketing platform 230 identifies (e.g., from the marketing information) a diner in downtown Palo Alto that serves lunch, and identifies three advertisements (e.g., A, B, and C) for the diner in the marketing information. Further, assume that marketing platform 230 calculates a score of 0.2 for advertisement A, a score of 0.3 for advertisement B, and a score of 0.7 for advertisement C based on the factors and the assigned weights associated with the marketing information. In such an example, marketing platform 230 may identify advertisements A-C as advertisements to provide to the particular users, may identify only advertisement C to be provided to the particular users since advertisement C has the greatest score, etc. In some implementations, marketing platform 230 may identify, for providing to the particular users, all of the advertisements, advertisements with scores greater than a particular threshold, a top percentage of advertisements based on the scores, etc.

As further shown in FIG. 4B, process 400 may include causing the advertisement to be provided to the particular users (block 470). For example, marketing platform 230 may cause the advertisement to be provided to the particular users (e.g., to user devices 210 associated with the particular users). In some implementations, marketing platform 230 may provide the advertisement directly to user devices 210 associated with the particular users. For example, assume that marketing platform 230 determines that an advertisement for an antique furniture store is to be provided to user devices 210 associated with particular users interested in antique furniture, via an email message. In such an example, marketing platform 230 may generate the email message, with the advertisement, and may provide the email message directly to user devices 210 associated with the particular users interested in antique furniture. In some implementations, marketing platform 230 may cause the advertisement to be provided to the particular users in response to an event. For example, assume that marketing platform 230 determines that an advertisement for a free drink at a restaurant is to be provided, to user device 210 associated with a particular user who frequently eats at the restaurant, when the particular user is located close to the restaurant (e.g., but not when the particular user is located more than a particular number of miles from the restaurant).

In some implementations, marketing platform 230 may instruct marketing system 220 to provide the advertisement to user devices 210 associated with the particular users. For example, assume that marketing platform 230 determines that an advertisement for a free cup of coffee at a coffee shop is to be provided, to user devices 210 associated with particular users who frequently drink coffee at the coffee shop, via a SMS message. In such an example, marketing platform 230 may instruct marketing system 220 to generate the SMS message, with the advertisement for the free cup of coffee. Marketing system 220 may provide the SMS message to user devices 210 associated with the particular users who frequently drink coffee at the coffee shop.

As further shown in FIG. 4B, process 400 may include receiving feedback associated with the advertisement from the particular users (block 480). For example, marketing platform 230 may receive feedback associated with the advertisement from user devices 210 associated with the particular users. In some implementations, marketing platform 230 may receive the feedback directly from user devices 210 associated with the particular users. In some implementations, user devices 210 associated with the particular users may provide the feedback to marketing system 220 (or another device), and marketing system 220 (or the other device) may provide the feedback to marketing platform 230. In some implementations, the feedback may include information indicating whether the particular users were provided the advertisement, purchased products/services associated with the advertisement, visited web pages relating to the advertisements, requested that the advertisements not be provided in the future, etc.

For example, assume that marketing platform 230 causes an advertisement for a fishing rod to be provided to user devices 210 associate with three particular users (e.g., A, B, and C). Further, assume that particular user A utilizes a link from the advertisement to purchase the fishing rod online, that particular user B receives the advertisement and visits a web page but does not purchase the fishing rod, and that particular user C requests that such emails not be provided in the future. Information associated with the actions of particular users A-C may be provided as feedback to marketing platform 230, where the feedback for particular user A may be considered the best feedback (e.g., for marketing purposes), the feedback for particular user B may be considered the next best feedback, and the feedback for particular user C may be considered the worst feedback.

As further shown in FIG. 4B, process 400 may include utilizing the feedback to refine the identification of the particular user profiles (block 490). For example, marketing platform 230 may utilize the feedback to refine the identification of the particular user profiles that include the one or more particular attributes. In some implementations, marketing platform 230 may utilize the feedback to modify the machine learning algorithms used to identify the particular user profiles, inputs associated with the machine learning algorithms, etc. In some implementations, marketing platform 230 may modify a particular user profile associated with a particular user from which the feedback is received.

For example, assume that marketing platform 230 creates a user profile for a user (e.g., Bob) that is interested in computers, and determines that the user profile (e.g., Bob) includes a particular attribute (e.g., indicating that Bob is interested in computers). Marketing platform 230 may cause an advertisement for a computer to be provided (e.g., via an email message) to user device 210 associated with Bob (e.g., via network 240). However, Bob may not utilize email very often, and this information may be utilized as feedback by marketing platform 230. Marketing platform 230 may modify the user profile (e.g., for Bob) to indicate that email advertising should be replaced with another form of advertising (e.g., SMS advertising).

In some implementations, marketing platform 230 may utilize the feedback to improve other functions provided by marketing platform 230, such as, for example, creating the user profiles, determining the advertisements to provide to the particular users, etc.

Although FIGS. 4A and 4B show example blocks of process 400, in some implementations, process 400 may include additional blocks, fewer blocks, different blocks, or differently arranged blocks than those depicted in FIGS. 4A and 4B. Additionally, or alternatively, two or more of the blocks of process 400 may be performed in parallel.

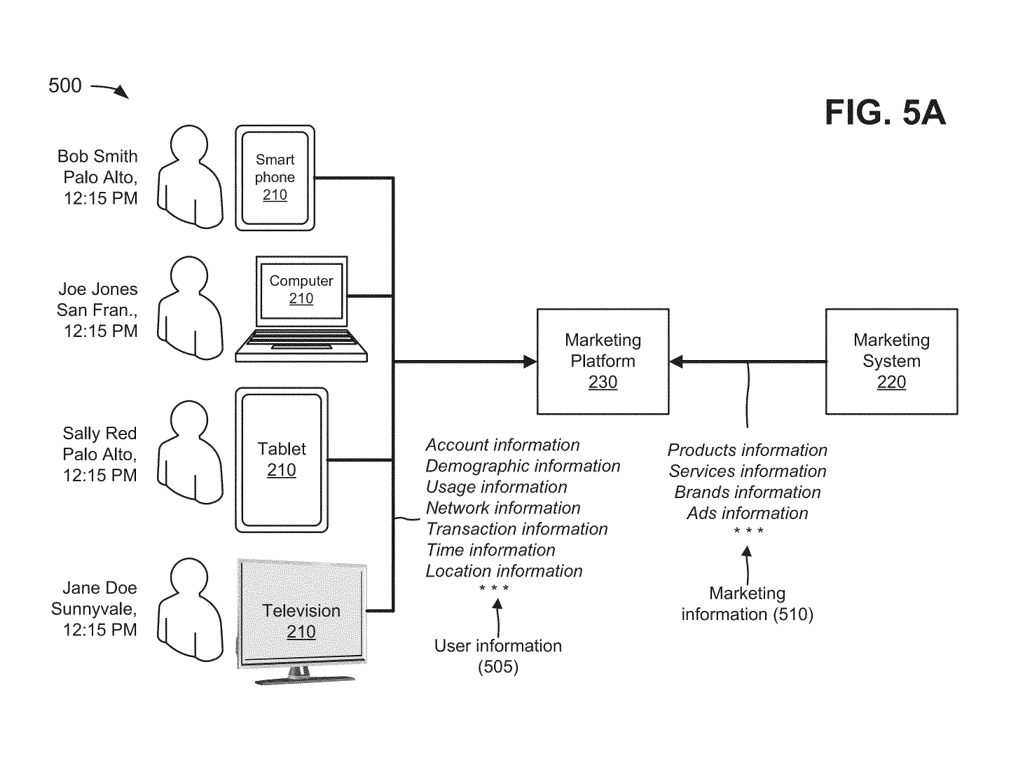

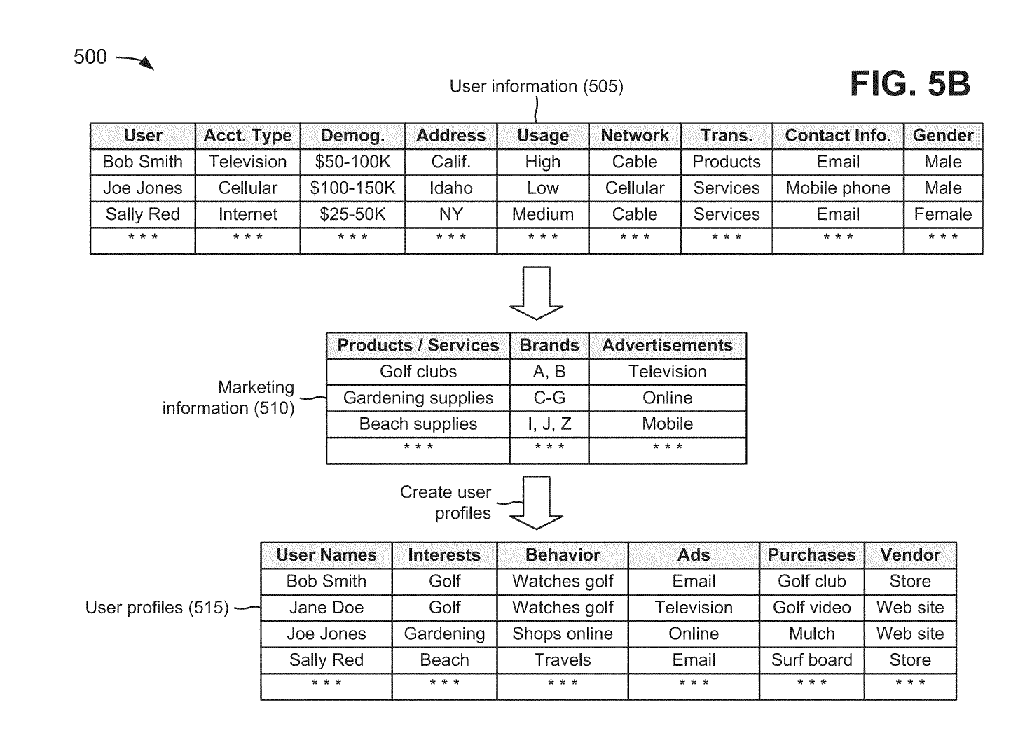

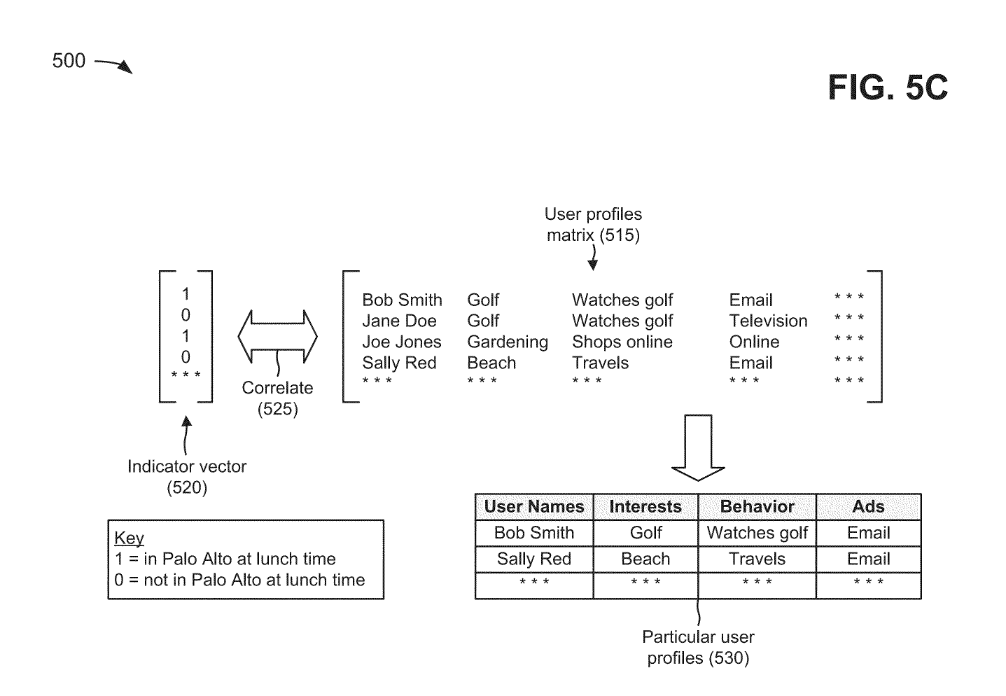

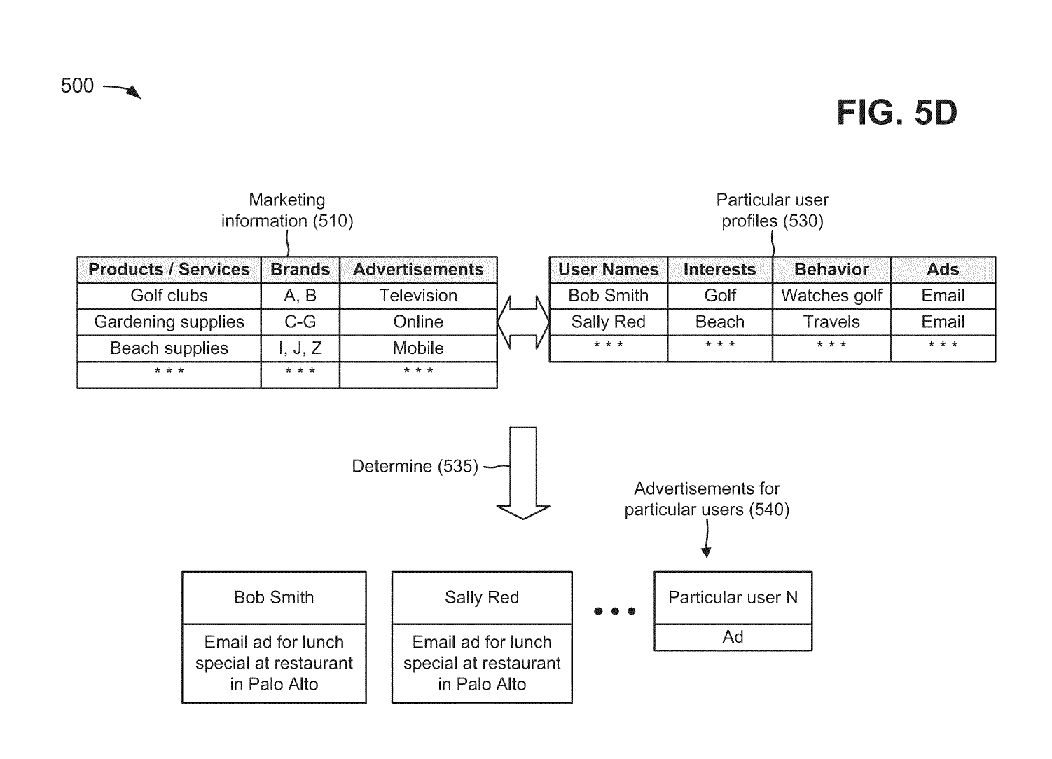

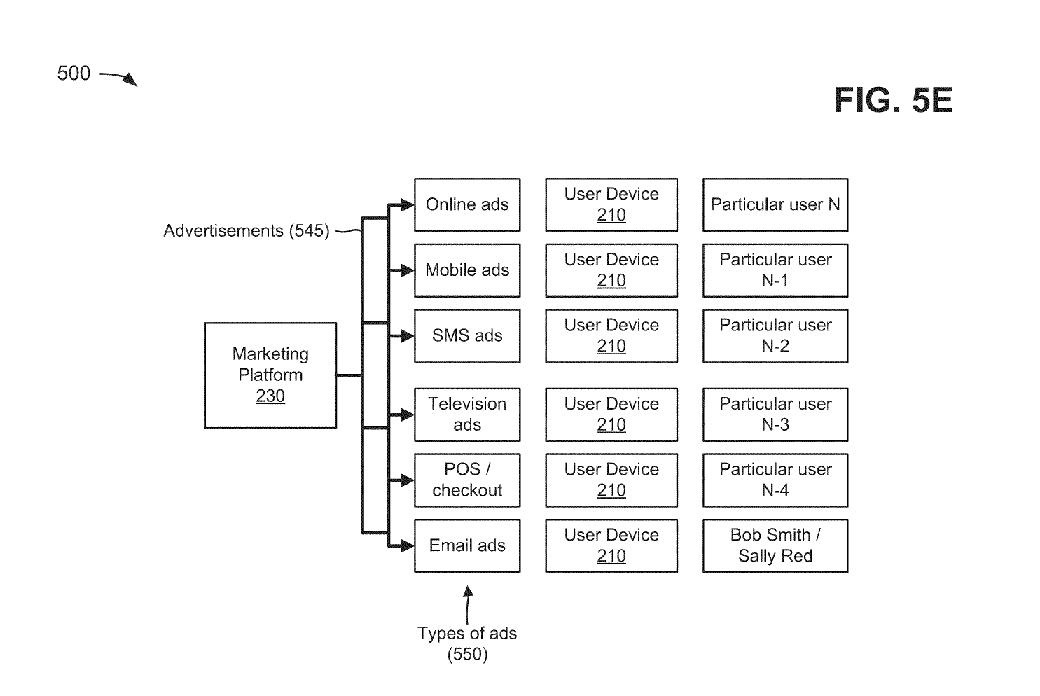

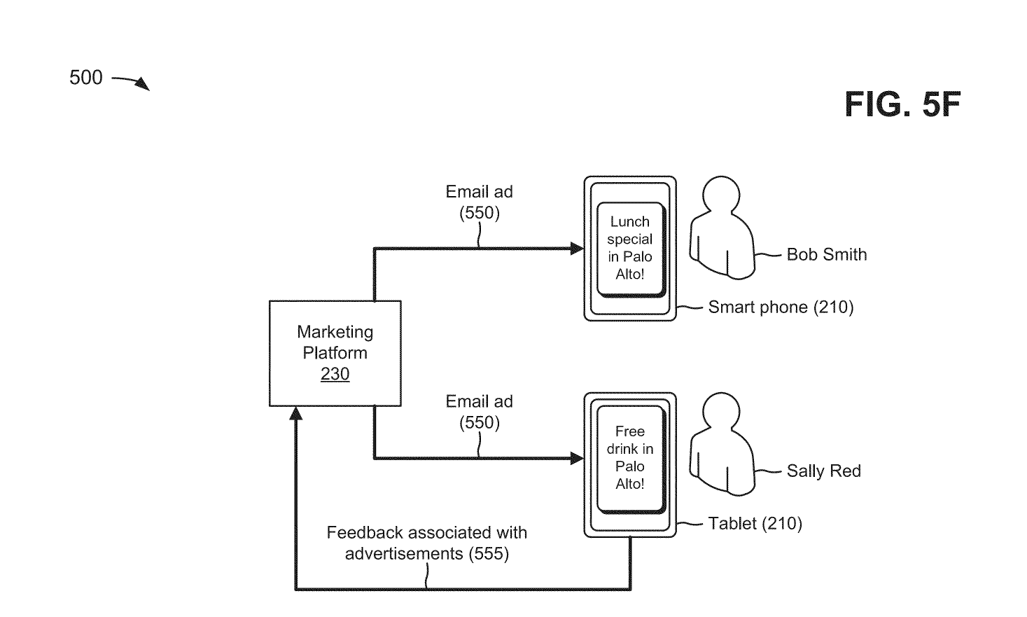

FIGS. 5A-5F are diagrams of an example 500 relating to example process 400 shown in FIGS. 4A and 4B. With reference to FIG. 5A, assume that users are associated with a variety of user devices 210 (e.g., smart phones, computers, tablets, televisions, etc.) that provide user information 505. User information 505 may include information associated with user devices 210 and the users (e.g., account information, demographic information, etc.); network information (e.g., information associated with network resources of network 240 utilized by user devices 210); network usage information associated with user devices 210; content accessed by user devices 210; transactions associated with user devices 210; clickstream information associated with user devices 210; location information associated with user devices 210; time information associated with user devices 210; etc. User devices 210 may provide user information 505 to marketing platform 230, and marketing platform 230 may receive user information 505.

As further shown in FIG. 5A, a first user device 210 (e.g., a smart phone 210) may be associated with a user (e.g., Bob Smith) who is located in Palo Alto at 12:15 PM. A second user device 210 (e.g., a computer 210) may be associated with a user (e.g., Joe Jones) who is located in San Francisco at 12:15 PM. A third user device 210 (e.g., a tablet 210) may be associated with a user (e.g., Sally Red) who is located in Palo Alto at 12:15 PM. A fourth user device 210 (e.g., a television 210) may be associated with a user (e.g., Jane Doe) who is located in Sunnyvale at 12:15 PM. In some implementations, marketing platform 230 may receive and store current location information and current time information associated with user devices 210 (e.g., as part of user information 505). Marketing platform 230 may utilize the current location information and the current time information to serve lunch advertisements (e.g., with local restaurants) to those users currently in a vicinity of a location (e.g., Palo Alto). In some implementations, marketing platform 230 may utilize user information 505 to predict which users will be in the vicinity at some point in time (e.g., because particular users frequent the vicinity at lunch time, because of web surfing performed by particular users relative to the vicinity (e.g., a web search for restaurants in Palo Alto), because of directional and velocity information associated with user devices 210, etc.).

As further shown in FIG. 5A, marketing system 220 may provide marketing information 510 that includes information associated with products and/or services offered by vendors and to be marketed to the users; advertisements for the products and/or the services offered by the vendors; brands information; marketing campaign information; user information 505 received by the vendors via interactions between the vendors and the users; etc. Marketing system 220 may provide marketing information 510 to marketing platform 230, and marketing platform 230 may receive marketing information 510.

As shown in FIG. 5B, marketing platform 230 may store user information 505 in a data structure (e.g., a tree, a table, a list, a database, etc.) that includes a user field, an account type field, a demographic field, an address field, a usage field, a network field, a transaction field, a contact information field, a gender field, and multiple entries associated with the fields. The user field may include information identifying the users of user devices 210, such as, for example, names, user identifiers, user account numbers, etc. The account type field may include information identifying types of accounts associated with the users, such as, for example, a television service account, a cellular service account, an Internet service account, etc. The demographic field may include information identifying demographics of the users, such as, for example, income levels of the users, education levels of the users, age, race, etc. The address field may include information identifying home addresses of the users. The usage field may include information identifying network usage by the users, such as, for example, high network usage, medium network usage, low network usage, bandwidth utilization, etc. The transaction field may include information identifying transactions performed by the users with user devices 210, such as, for example, transactions for products, services, etc. The contact information field may include information identifying contact information (e.g., email addresses, mobile phone numbers, home phone numbers, etc.) for the users. The gender field may include information identifying genders (e.g., male versus female) of the users.

As further shown in FIG. 5B, marketing platform 230 may store marketing information 510 in a data structure that includes a products/services field, a brands field, an advertisements field, and multiple entries associated with the fields. The products/services field may include information identifying products/services that vendors wish to sell to users, such as, for example, golf clubs, gardening supplies, beach supplies, etc. The brands field may include information identifying brands associated with the products/services, such as, for example, brands A and B for the golf clubs, brands C-G for the gardening supplies, brands I, J, and Z for the beach supplies, etc. The advertisements field may include information identifying advertisements associated with the products/services, such as, for example, television advertisements for the golf clubs, online advertisements for the gardening supplies, mobile advertisements for the beach supplies, etc. that may be shown on television (e.g., via a STB), via an email message, via a SMS message, etc.

Marketing platform 230 may generate user profiles 515 based on user information 505 and marketing information 510, as further shown in FIG. 5B. A user profile 515, for a user, may include a user identifier and multiple attributes associated with the user (e.g., demographic information, location information, time information, user device information, interests, behavior, advertisements received, etc.). As shown, marketing platform 230 may store user profiles 515 in a data structure that includes a user names field, an interests field, a behavior field, an advertisements field, a purchases field, a vendor field, and multiple entries associated with the fields. The user names field may include information identifying the names of the users of user devices 210, such as, for example, Bob Smith, Jane Doe, Joe Jones, Sally Red, etc. The interests field may include information identifying interests of the users, such as, for example, golf, gardening, beach, etc. The behavior field may include information identifying behaviors of the users, such as, for example, watching golf, shopping online, traveling, etc.

The advertisements field may include information identifying advertisements provided to the users and a manner in which the advertisements are provided (e.g., via television, via online, via email, via SMS, etc.). For example, a user may receive a golf advertisement via email, a car advertisement via a SMS message, and a travel advertisement via television. The purchases field may include information identifying products/services purchased by the users, such as, for example, a golf club, a golf video, mulch, a surf board, etc. The vendor field may include information identifying vendors from which the products/services are purchased, such as, for example, a store for a vendor, a web site for a vendor, etc.

With reference to FIG. 5C, marketing platform 230 may define particular attributes for marketing a particular product/service. For example, marketing platform 230 may wish to market a lunch special for a restaurant that serves lunch in downtown Palo Alto (e.g., between the hours of 11:00 AM and 2:00 PM). Thus, marketing platform 230 may define a location attribute and a time attribute as particular attributes that are relevant for marketing the lunch special for the restaurant. As shown in FIG. 5C, marketing platform 230 may create an indicator vector 520 that includes entries that equal “1” if the particular attributes are satisfied and may include entries that equal “0” if at least one of the particular attributes is not satisfied. For example, if a particular user is located at the particular location (e.g., downtown Palo Alto) at the particular time (e.g., between 11:00 AM to 2:00 PM), the entry for the particular user in indicator vector 520 may be set to “1.” However, if the particular user is located at another location (e.g., San Francisco, Calif.) at the particular time, the entry for the particular user in indicator vector 520 may be set to “0.”

As further shown in FIG. 5C, user profiles 515 may be provided as a matrix of information, and marketing platform 530 may correlate 525 user profiles 515 with indicator vector 520 in order to identify particular user profiles 530 (e.g., of user profiles 515) that include the particular attributes (e.g., located in downtown Palo Alto at lunch time). A particular user profile 530, for a particular user, may include a user identifier (e.g., Bob Smith) and multiple attributes associated with the particular user (e.g., demographic information, location information, time information, user device information, interests, behavior, advertisements received, etc.). As shown, marketing platform 230 may store particular user profiles 530 in a data structure that includes a user names field, an interests field, a behavior field, an advertisements field, and multiple entries associated with the fields.

For example, marketing platform 230 may identify a particular user profile 530, for a particular user (e.g., Bob Smith) since Bob Smith is located in downtown Palo Alto at lunch time. Particular user profile 530 may include information associated with interests (e.g., golf), behavior (e.g., watches golf), and advertisements (e.g., email) for Bob Smith. Marketing platform 230 may identify another particular user profile 530, for another particular user (e.g., Sally Red) since Sally Red is located in downtown Palo Alto at lunch time. Particular user profile 530 may include information associated with interests (e.g., beach), behavior (e.g., travels), and advertisements (e.g., email) for Sally Red. Marketing platform 230 may continue this process until all of particular user profiles 530 are identified for the particular attributes.

As shown in 5D, marketing platform 230 may utilize marketing information 510 and particular user profiles 530 in order to determine 535 advertisements for the particular users, as indicated by reference number 540. For example, marketing platform 230 may associate an email advertisement (e.g., for a lunch special at the restaurant in Palo Alto) with a particular user (e.g., Bob Smith), may associate another email advertisement (e.g., for a lunch special at the restaurant in Palo Alto) with another particular user (e.g., Sally Red), etc.

As shown in FIG. 5E, marketing platform 230 may provide advertisements 545 to user devices 210 associated with the particular users. Marketing platform 530 may deliver advertisements 545 to the particular users in a variety of ways, as indicated by reference number 550 in FIG. 5E. For example, marketing platform 530 may deliver advertisements 545 as an online advertisement, as a mobile advertisement, as a SMS advertisement, as a television advertisement, on a receipt from a POS/checkout device, as an email advertisement, etc. As further shown in FIG. 5E, marketing platform 530 may deliver online advertisements 550 to user device 210 associated with particular user N, may deliver mobile advertisements 550 to user device 210 associated particular user N-1, may deliver SMS advertisements 550 to user device 210 associated with particular user N-2, may deliver television advertisements 550 to user device 210 associated with particular user N-3, may utilize a POS/checkout device for particular user N-4, and may deliver email advertisements 550 to user devices 210 associated with Bob Smith and Sally Red.

As shown in FIG. 5F, marketing platform 230 may deliver, to smart phone 210 associated with Bob Smith, an email advertisement 550 that indicates that a lunch special is available at the restaurant in downtown Palo Alto (e.g., near where Bob Smith is located). Marketing platform 230 may deliver, to tablet 210 associated with Sally Red, an email advertisement 550 that indicates that Sally Red may receive a free drink at the restaurant in downtown Palo Alto. Bob Smith and/or Sally Red may buy lunch at the restaurant based on advertisements 550 or may do nothing based on advertisements 550. Such information may be provided as feedback 555 to marketing platform 230, as further shown in FIG. 5F. Marketing platform 230 may utilize feedback 555 to refine the identification of particular user profiles 530 based on user profiles 515 and indicator vector 520.

As indicated above, FIGS. 5A-5F are provided merely as an example. Other examples are possible and may differ from what was described with regard to FIGS. 5A-5F.

Systems and/or methods described herein may provide a marketing platform that identifies particular attributes for particular user profiles generated by the marketing platform, and that provides advertisements to particular users associated with the particular user profiles. The systems and/or methods may ensure that personalized advertisements are delivered to the particular users at appropriate times and locations. The systems and/or methods may enable vendors to allocate marketing budgets so that the personalized advertisements are provided to the particular users in a most productive manner.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of hardware, firmware, and/or combinations of software and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, user information associated with users of user devices;
receiving, by the device, marketing information associated with advertisements for at least one of products or services;
creating, by the device, user profiles, associated with the users, based on the user information,
each of the user profiles including a user identifier for each user and a plurality of attributes associated with each user;
defining, by the device, at least one particular attribute associated with at least one of the advertisements;
identifying, by the device, a particular user profile, of the user profiles, that includes the at least one particular attribute,
the particular user profile being associated with a particular user, and
the particular user being associated with a particular user device;
determining, by the device, a particular advertisement to provide to the particular user device based on the particular user profile and the marketing information; and
causing, by the device, the particular advertisement to be provided to the particular user device.

2. The method of claim 1, further comprising:
receiving, from the particular user device, feedback associated with the particular advertisement; and
utilizing the feedback to refine the identification of the particular user profile.

3. The method of claim 1, further comprising:
receiving, from the particular user device, feedback associated with the particular advertisement; and
utilizing the feedback to refine a determination of a future advertisement to provide to the particular user device.

4. The method of claim 1, where determining the particular advertisement comprises:
assigning weights to the marketing information;
calculating scores for the advertisements based on the assigned weights; and
selecting the particular advertisement, from the advertisements, based on the calculated scores for the advertisements.

5. The method of claim 1, where identifying the particular user profile comprises:
utilizing the user profiles in a machine learning algorithm; and
solving the machine learning algorithm, based on the user profiles and the at least one particular attribute, to identify the particular user profile.

6. The method of claim 1, where defining the at least one particular attribute comprises:
receiving a request to market a particular product or service of the at least one of the products or the services; and
selecting, based on the request, the at least one particular attribute from a plurality of attributes associated with the user profiles,
the at least one particular attribute being relevant to marketing the particular product or service.

7. The method of claim 1, where the particular user profile includes:
a user identifier for the particular user, and
a plurality of attributes based on information relating to the particular user.

8. A system, comprising:
one or more devices to:
receive user information associated with users of user devices;
receive marketing information associated with advertisements for at least one of products or services;
generate user profiles, associated with the users, based on the user information,
each of the user profiles including a user identifier for each user and a plurality of attributes associated with each user;
determine a plurality of particular attributes associated with at least one of the advertisements;
identify a particular user profile, of the user profiles, that includes the plurality of particular attributes,
the particular user profile being associated with a particular user, and
the particular user being associated with a particular user device;
determine a particular advertisement to provide to the particular user device based on the particular user profile and the marketing information; and
cause the particular advertisement to be provided to the particular user device.

9. The system of claim 8, where the one or more devices are further to:
receive, from the particular user device, feedback associated with the particular advertisement; and
utilize the feedback to modify the identification of the particular user profile.

10. The system of claim 8, where the one or more devices are further to:
receive, from the particular user device, feedback associated with the particular advertisement; and
utilize the feedback to modify the determination of the plurality of particular attributes.

11. The system of claim 8, where, when determining the particular advertisement, the one or more devices are further to:
assign weights to the marketing information;
calculate scores for the advertisements based on the assigned weights; and
select the particular advertisement, from the advertisements, based on the calculated scores for the advertisements and based on the particular user profile.

12. The system of claim 8, where, when identifying the particular user profile, the one or more devices are further to:
utilizing the user profiles in a regularized regression algorithm; and
solve the regularized regression algorithm, based on the user profiles and the plurality of particular attributes, to identify the particular user profile.

13. The system of claim 8, where, when determining the plurality of particular attributes, the one or more devices are further to:
identify a particular product or service, of the at least one of the products or the services, to be marketed; and
select, based on the particular product or service, the plurality of particular attributes from attributes associated with the user profiles,
the plurality of particular attributes being relevant to marketing the particular product or service.

14. The system of claim 8, where, when identifying the particular user profile, the one or more devices are further to:
identify a set of user profiles, from the user profiles, that includes the plurality of particular attributes; and
select the particular user profile from the set of user profiles.

15. A computer-readable medium storing instructions, the instructions comprising:
one or more instructions that, when executed by one or more processors of a device, cause the one or more processors to:
receive user information associated with users of user devices;
receive marketing information associated with advertisements for at least one of products or services;
generate user profiles, associated with the users, based on the user information,
each of the user profiles including a user identifier for each user and a plurality of attributes associated with each user;
determine at least one particular attribute associated with at least one of the advertisements;
identify a particular user profile, of the user profiles, that includes the at least one particular attribute,
the particular user profile being associated with a particular user, and
the particular user being associated with a particular user device;
determine a particular advertisement to provide to the particular user device based on the particular user profile and the marketing information;
cause the particular advertisement to be provided to the particular user device; and
receive, from the particular user device, feedback associated with the particular advertisement.

16. The computer-readable medium of claim 15, further comprising:
one or more instructions that, when executed by the one or more processors, cause the one or more processors to:
utilize the feedback to modify the identification of the particular user profile.

17. The computer-readable medium of claim 15, further comprising:
one or more instructions that, when executed by the one or more processors, cause the one or more processors to:
utilize the feedback to:
modify a determination of a future advertisement to provide to the particular user device, or
modify the determination of the at least one particular attribute.

18. The computer-readable medium of claim 15, where the one or more instructions to determine the particular advertisements further comprise:
one or more instructions that, when executed by the one or more processors, cause the one or more processors to:
assign weights to the marketing information;
calculate scores for the advertisements based on the assigned weights; and
select the particular advertisement, from the advertisements, based on the calculated scores for the advertisements and based on the particular user profile.

19. The computer-readable medium of claim 15, where the one or more instructions to identify the particular user profile further comprise:
one or more instructions that, when executed by the one or more processors, cause the one or more processors to:
utilize the user profiles in a machine learning algorithm; and
solve the machine learning algorithm, based on the user profiles and the at least one particular attribute, to identify the particular user profile.

20. The computer-readable medium of claim 15, where the particular user profile includes:
a user identifier for the particular user, and
a plurality of attributes based on information relating to the particular user.
